(19) United States
(12) Patent Application Publication
(10) Pub. No.: US 2006/0142068 A1
(43) Pub. Date: Jun. 29, 2006

(54) Electronic apparatus

(76) Inventors: Erika Reponen, Tampere (FI); Antti Aaltonen, Tampere (FI); Tero Hakala, Kangasala (FI); Joonas Itaranta, Tampere (FI); Marja Salmimaa, Tampere (FI); Mika Pesonen, Tampere (FI)

Correspondence Address: PERMAN & GREEN, 425 POST ROAD, FAIRFIELD, CT, 06824, US

(21) Appl. No.: 11/023,080

(22) Filed: Dec. 27, 2004

(51) Int. Cl. H04B 1/38; H04M 1/00

(52) U.S. Cl. 455/566

(57) ABSTRACT

An electronic apparatus, a message sender, a message receiver, and a mobile communication apparatus is disclosed. The electronic apparatus and the mobile communication apparatus include an input means arranged to receive instructions from a user, a processor arranged to assign parameters for three-dimensional viewing of items, wherein the parameters depend on the instructions, and a display arranged to view the items according to the parameters. The mobile communication apparatus further includes a message sender and a message receiver. The message sender includes a message editor arranged to generate messages including one or more pictographs according to instructions from a user, and a sending means arranged to send messages generated by the message editor. The message receiver includes a message receiving means arranged to receive a message including one or more three-dimensional pictographs, and a message viewer arranged to view the message.

### BACKGROUND OF THE INVENTION

1. Field of the Invention

The present invention relates to an electronic apparatus, a message sender, a message receiver, and a mobile communication apparatus comprising such a message sender and message receiver.

2. Brief Description of Related Developments

By the increased use of mobile communication apparatuses, many people are given the opportunity to get in contact with each other practically anywhere at any time. The contact may take the form of e.g. a voice call or a short text message. Examples of systems for providing this kind of mobile services are DAMPS, PCM, GSM and UMTS.

A mobile communication apparatus normally comprises a. display for showing items, which relate to menus, messages, etc, text, and numbers. For example, it is common to view icons relating to functions or applications to facilitate the use of the functions and applications for a user.

In particular, the use of mobile communication apparatuses for sending and receiving messages by means of e.g. Short Messaging Service (SMS), Enhanced Messaging Service (EMS), Multimedia Messaging Service (MMS), Email and Instant Messaging (IM) has become very popular due to their fast and convenient way of exchanging information.

Even though many mobile communication apparatuses includes functionality for sending and receiving messages, the way of communicating by use of characters in the messages, even though accentuated by emoticons, i.e. emotion expressing icons, e.g. smileys, does not provide a really personal personal communication. Images can be includes in messages, e.g. in MMS, but is often of the character of factual material, e.g. photos, and not an expression of e.g. feelings, emotions, states and happenings.

It is therefore a desire to improve viewing of items.

### SUMMARY OF THE INVENTION

The present invention is based on the understanding that viewing three-dimensional items will improve usability of a mobile communication apparatus.

The present invention is also based on the understanding that pictographs created or composed by a person are able to convey a large amount of information e.g. about feelings, emotions, states and happenings, especially if the person is able to create or compose three-dimensional pictographs.

Therefore, according to a first aspect of the present invention, it is provided an electronic apparatus comprising an input means arranged to receive instructions from a user; a processor arranged to assign parameters for three-dimensional viewing of items, wherein said parameters depend on said instructions; and a display arranged to view said items according to said parameters.

An advantage of this is more freedom to view items such that a user is able to achieve more information in an easily comprehensive way.

A three-dimensional viewpoint for a user among said items may be depending on the parameters. The parameters for three-dimensional viewing may comprise relation, relative size, orientation or location, or any combination thereof of the items. The one or more items may comprise a menu item, a message, a phone book entry, an icon, or an image, or any combination thereof.

Advantages of this is a suitable implementation of three-dimensional viewing.

According to a second aspect of the present invention, it is provided a message sender comprising a message editor arranged to generate messages comprising one or more three-dimensional pictographs according to instructions from a user, and a sending means arranged to send messages generated by said message editor.

An advantage of this is that it enables communication by three-dimensional pictographs, which in turn enables improved communication, since the personal editing of the pictographs is conveyed by the creation of the three-dimension pictograph message. The three-dimensional pictographs improves the editor's freedom to express emotions, feelings states and happenings in the message.

By a “pictograph”, it is meant a pictoral symbol for a word, phrase, or expression of emotion, feeling, state or happening.

The message sender may further comprise a catalogue comprising a plurality of three-dimensional pictographs and connected to the message editor, wherein the message editor is arranged to import pictographs to be comprised in the generated messages from the catalogue. The message sender may further comprise means to access a remote catalogue comprising a plurality of three-dimensional pictographs and connected to the message editor, wherein the message editor is arranged to import pictographs to be comprised in the generated messages from the remote catalogue. Advantages of these features is that a user is able to get three-dimensional pictographs to use in the messages.

The message editor may be arranged to assign a relation, relative size, orientation and location of each pictograph in said message according to instructions from a user. An advantage of this is that these parameters, when as here, chosen by the user, can convey further information.

The message sending means may be connected to communication means comprising an infrared data association (IrDA), a short range radio connection, a Bluetooth connection, a connection to a wireless local area network (WLAN), or a connection to a telecommunication network, or any combination thereof.

The message editor may be connected to a three-dimensional user interface.

By a “three-dimensional user interface” it is meant a user interface that is enabled to provide three-dimensional images to a user.

According to a third aspect of the present invention, it is provided a message receiver comprising a message receiving means arranged to receive a message comprising one or more three-dimensional pictographs, and a message viewer arranged to view said message.

An advantage of this is that it enables reception of three-dimensional pictograph messages, which in turn enables improved communication, since the personal interpretation of the pictographs implies information conveyed by the creation of the three-dimensional pictograph message. The three-dimensional pictographs improves the ability to share e.g. emotions, feelings, states and happenings in the message.

The message viewer may be arranged to view said messages as they were composed in sense of relations, relative sizes, orientations and locations of pictographs comprised in said message.

An advantage of this is that the originality of the message is improved to express information intended to be conveyed.

The message viewer is arranged to change a three-dimensional viewpoint of said message according to instructions from a user.

An advantage of this is that a user is able to move into the message and experience inner thoughts conveyed by it.

The message receiving means may be connected to communication means comprising an infrared data association (IrDA), a short range radio connection, a Bluetooth connection, a connection to a wireless local area network (WLAN), or a connection to a telecommunication network, or any combination thereof.

The message viewer may be connected to a three-dimensional user interface.

According to a fourth aspect of the present invention, it is provided a mobile communication apparatus comprising a an input means arranged to receive instructions from a user; a processor arranged to assign parameters for three-dimensional viewing of items, wherein said parameters depend on said instructions; and a display arranged to view said items according to said parameters; a message sender according to the second aspect of the present invention; and a message receiver according to the third aspect of the present invention.

An advantage of this, beyond the advantages of those of the first, second and third aspects, is that three-dimensional messaging is enabled in a mobile communication apparatus.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a block diagram schematically showing a mobile communication apparatus according to an embodiment of the present invention;

FIG. 2 shows a mobile communication apparatus according an embodiment of to the present invention;

FIG. 3 is a block diagram schematically showing a message sender according to an embodiment of the present invention;

FIG. 4 is a block diagram schematically showing a message receiver according to an embodiment of the present invention; and

FIG. 5 illustrates three-dimensional scrolling. through items according to an embodiment of the present invention.

### DETAILED DESCRIPTION OF PREFERRED EMBODIMENTS

There are different ways of displaying three-dimensional objects on a screen, among those the use of perspective, which has been used by painters for several of hundred years, the use of special glasses to a receive stereoscopic view, viewing by tracking the location of the user thus arranging the displayed objects accordingly, or use of special display screens where a user experiences a three-dimensional image.

An electronic apparatus with a three-dimensional user interface is be arranged to view items according to parameters in sense of sizes, orientations, and locations of the items, and especially the relations between the items. The apparatus can comprise means for converting the items to a form being able to view at the present situation, where the user experience sizes, orientations, and locations of the items, and the relations between the items in in a comprehensive way. The apparatus can also comprise means for changing a three-dimensional viewpoint of the items according to instructions from a user through input means. For example, the user is able to make a “walkabout” among the three-dimensionally presented items. The three-dimensional user interface can also comprise a scrolling function to enable a user to scroll between items in a direction perpendicular to an image plane of a display of the apparatus.

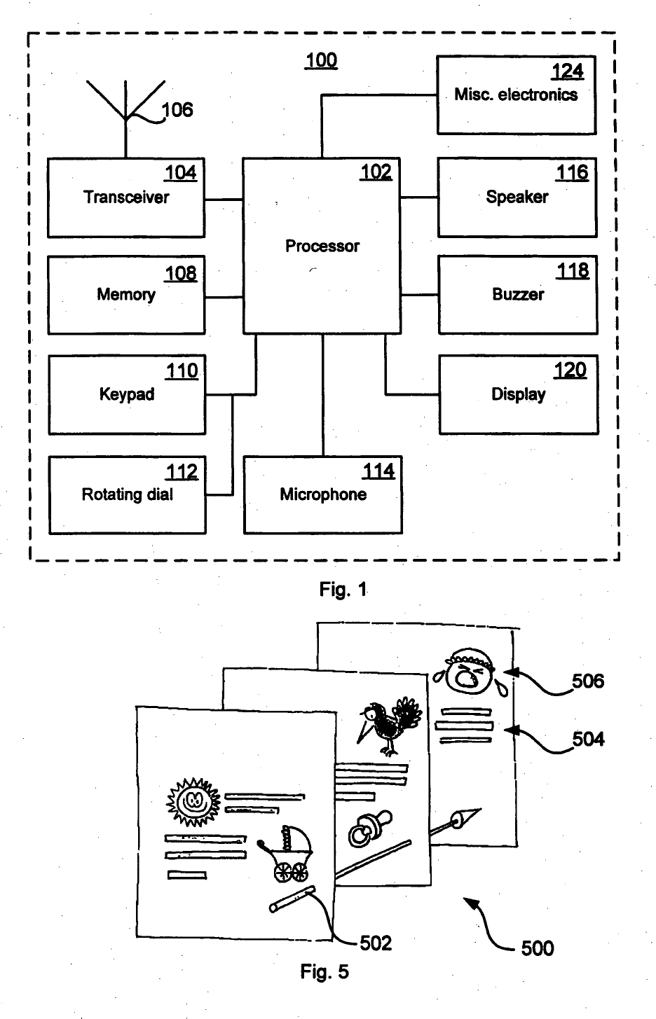

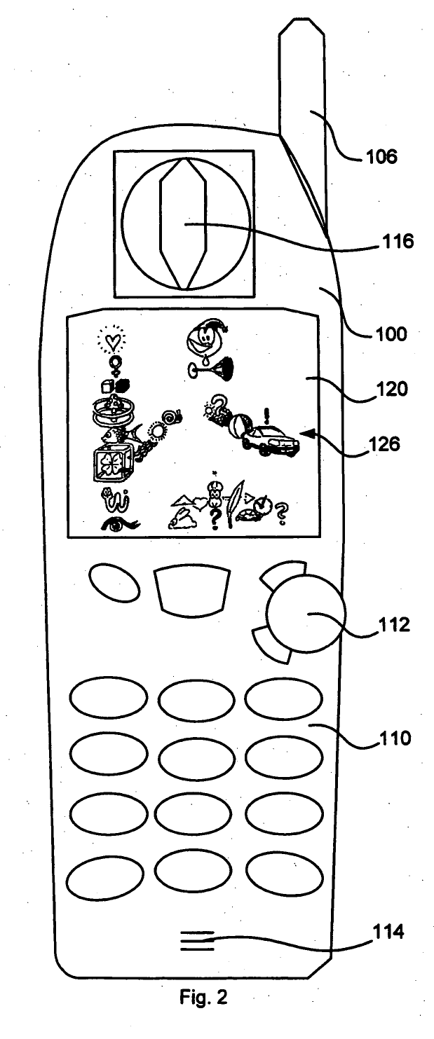

FIG. 1 is a block diagram schematically showing a mobile communication apparatus 100 according to an embodiment of the present invention, and FIG. 2 shows a mobile communication apparatus 100. The mobile communication apparatus 100 comprises a processor 102 which is arranged to control functions of the mobile communication apparatus 100. In FIG. 1, the connections between elements 104, 108, 110, 112, 114, 116, 118, 120, 124 and the processor 102 depicts the control of the elements, as well as signal transfer and information exchange. However, the elements 104, 108, 110, 112, 114, 116, 118, 120, 124 can have any interconnection for signals or information transfer to any of the other elements 104, 108, 110, 112, 114, 116, 118, 120, 124, which is not shown in FIG. 1 for clarity reasons. The mobile communication apparatus 100 further comprises a transceiver 104 connected to the processor 102 which is arranged to receive and transmit radio signals through an antenna 106. The mobile communication apparatus can further comprise a memory 108, a keypad 110, a rotating dial 112, a microphone 114, a speaker 116, a buzzer 118, and a display 120. Further miscellaneous electronics 124, such as means for infrared data association (not shown), can also be comprised. In the display 120 of FIG. 2, a message or a part of a message is shown, comprising a plurality of three-dimensional pictographs 126.

The functions of the mobile communication apparatus 100 comprise a three-dimensional user interface, a message sender, and a message receiver, which is handled by the processor 102, with support of the elements 104, 106, 108, 110, 112, 114, 116, 118, 120, 124.

The three-dimensional user interface of the mobile communication apparatus 100 comprises the display 120, input means 110, 112, 114, and a processor 102, wherein. the processor 102 is arranged to control the display 120 upon instructions received from a user by the input means 110, 112, 114, and the processor 102 is arranged to assign parameters for three-dimensional viewing of the items, and the display 120 is arranged to view one or more items according to the parameters. A three-dimensional viewpoint for a user among the items is depending on the parameters. The parameters for three-dimensional viewing can comprise relation, relative size, orientation, and/or location. The items can comprise a menu item, a message, a phone book entry, an icon, and/or an image.

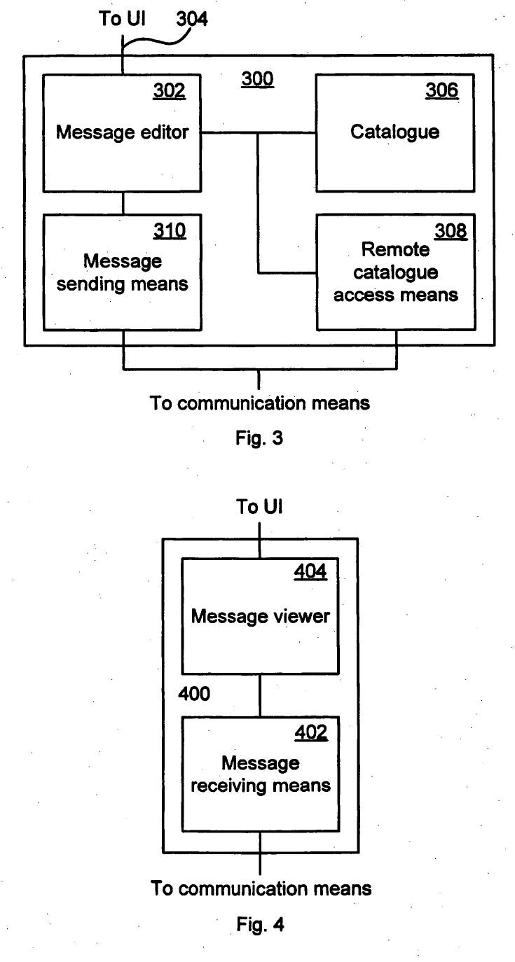

FIG. 3 is a block diagram schematically showing a message sender 300 according to an embodiment of the present invention. The message sender 300 comprises a message editor 302 to enable a user to create a message with one or more three-dimensional pictographs. The message editor 302 is in connection 304 with a three-dimensional user interface (UI). The user can select pre-stored three-dimensional pictographs from a catalogue 306, which can be locally stored on the mobile communication apparatus 100, or from a remote catalogue (not shown) remotlely stored and accessed by remote catalogue access means 308 via communication means (not shown), e.g. a telecommunication network, in which said message sender 300 is arranged to work, or alternatively an infrared data association (IrDA) or short range radio connection, such as Bluetooth or wireless local area network (WLAN).

The user can also create her own three-dimensional pictographs in the message editor 302. The user arranges one or more three-dimensional pictographs in a message by the message editor 302, and the pictographs can be animated or still objects. The message can be divided into parts, where animation can be performed between parts of the message. In the message editor 302, the user is able to set size, orientation, and location of the pictographs, and arrange the relations between the pictographs. The message can also comprise other images, text, sound objects, film clips, etc. The message sender also comprises message sending means 310 for sending the generated messages via the communication means.

FIG. 4 is a block diagram schematically showing a message receiver 400 according to an embodiment of the present invention. The message receiver 400 comprises a message receiving means 402 for receiving a message comprising one or more three-dimensional pictographs. The message can be received via communication means (not shown), e.g. a telecommunication network, in which said message receiver 400 is arranged to work, or alternatively an infrared data association (IrDA) or short range radio connection, such as Bluetooth or wireless local area network (WLAN). The message receiver 400 further comprises a message viewer 404 connected to a three-dimensional user interface (UI) for viewing the messages comprising three-dimensional pictographs. The message viewer. 404 can be arranged to view the messages the way they were composes by the sender in sense of sizes, orientations, and locations of the pictographs, and especially the relations between the pictographs. The message viewer 404 can comprise means for converting the messages to a form being able to view at the receiving side, where the user experience sizes, orientations, and locations of the pictographs, and the relations between the pictographs in the way the message was composed. The message viewer can also comprise means for changing a three-dimensional viewpoint of the message according to instructions from a user. The user is. then able to make a “walkabout” among the three-dimensional pictographs. The message viewer also comprise a scrolling function to enable a user to scroll between parts of the message.

FIG. 5 illustrates function of a three-dimensional user interface, where scrolling is enabled through items. 500, e.g. through message parts, menu items, phone book entries, etc., according to an embodiment of the present invention. The scrolling is then performed in a direction perpendicular to the image plane, i.e. a z-plane, of a display screen of the user interface. Alternatively, other ways of maneuvering in the z-plane can be used, together with maneuvering in the other directions of the display, i.e. the x-plane and the y-plane, e.g. as a walkabout among the items. A three-dimensional scroll indicator 502 can be viewed to indicate the three-dimensional position while scrolling through the items 500. The items 500 can comprise a mix of text 504 and images 506, e.g. three-dimensional pictographs. A three-dimensional viewpoint for a user among said items can be depending on user set parameters. The parameters for three-dimensional viewing can comprise relation, relative size, orientation or location, or any combination thereof. The one or more items can comprise a menu item, a message, a phone book entry, an icon, or an image, or any combination thereof. Further, the items can be images stored in a gallery, contacts with or without images or any items in a list provided by the user interface, or messages in an inbox, where sender data comprising portrait, phone number, addresses etc. from a contact database or message related information, such as shrunk image(s) or thumbnail of message.

1. An electronic apparatus comprising:
an input means arranged to receive instructions from a user;
a processor arranged to assign parameters for three-dimensional viewing of items, wherein said parameters depend on said instructions; and
a display arranged to view said items according to said parameters.

2. The electronic apparatus according to claim 1, wherein a three-dimensional viewpoint for a user among said items is depending on said parameters.

3. The electronic apparatus according to claim 1, wherein said parameters comprise relation, relative size, orientation or location, or any combination thereof of said items.

4. The electronic apparatus according to claim 1, wherein said one or more items comprise a menu item, a message, a phone book entry, an icon, or an image, or any combination thereof.

5. A message sender comprising a message editor arranged to generate messages comprising one. or more three-dimensional pictographs according to instructions from a user, and a sending means arranged to send messages generated by said message editor.

6. The message sender according to claim 5, further comprising a catalogue comprising a plurality of three-dimensional pictographs and connected to said message editor, wherein said message editor is arranged to import pictographs to be comprised in said generated messages from said catalogue.

7. The message sender according to claim 5, further comprising means to access a remote catalogue comprising a plurality of three-dimensional pictographs and connected to said message editor, wherein said message editor is arranged to import pictographs to be comprised in said generated messages from said remote catalogue.

8. The message sender according to claim 5, wherein said message editor is arranged to assign a relation, relative size, orientation and location of each pictograph in said message according to instructions from a user.

9. The message sender according to claim 5, wherein said message sending means is connected to communication means comprising an infrared data association (IrDA), a short range radio connection, a Bluetooth connection, a connection to a wireless local area network (WLAN), or a connection to a telecommunication network, or any combination thereof.

10. A message receiver comprising a message receiving means arranged to receive a message comprising one or more three-dimensional pictographs, and a message viewer arranged to view said message.

11. The message receiver according to claim 10, wherein said message viewer is arranged to view said messages as they were composed in sense of relations, relative sizes, orientations and locations of pictographs comprised in said message.

12. The message receiver according to claim 10, wherein said message viewer is arranged to change a three-dimensional viewpoint of said message according to instructions from a user.

13. The message receiver according to claim 10, wherein said message receiving means is connected to communication means comprising an infrared data association (IrDA), a short range radio connection, a Bluetooth connection, a connection to a wireless local area network (WLAN), or a connection to a telecommunication network, or any combination thereof.

14. A mobile communication apparatus comprising
an input means arranged to receive instructions from a user;
a processor arranged to assign parameters for three-dimensional viewing of items, wherein said parameters depend on said instructions;
a display arranged to view said items according to said parameters;
a message sender comprising a message editor connected to said catalogue and arranged to generate messages comprising one or more pictographs according to instructions through said input means from a user, and a sending means arranged to send messages generated by said message editor; and
a message receiver comprising a message receiving means arranged to receive a message comprising one or more three-dimensional pictographs, and a message viewer arranged to view said message by said display.

15. The mobile communication apparatus according to claim 14, wherein a three-dimensional viewpoint for a user among said items is depending on said parameters.

16. The mobile communication apparatus according to claim 14, wherein said parameters comprise relation, relative size, orientation or location, or any combination thereof of said items.

17. The mobile communication apparatus according to claim 1, wherein said one or more items comprise a menu item, a message, a phone book entry, an icon, or an image, or any combination thereof.

18. The mobile communication apparatus according to claim 14, further comprising a catalogue comprising a plurality of three-dimensional pictographs and connected to said message editor, wherein said message editor is arranged to import pictographs to be comprised in said generated messages from said catalogue.

19. The mobile communication apparatus according to claim 14, further comprising means to access a remote catalogue comprising a plurality of three-dimensional pictographs and connected to said message editor, wherein said message editor is arranged to import pictographs to be comprised in said generated messages from said remote catalogue.

20. The mobile communication apparatus according to claim 14, wherein said message editor is arranged to assign a relation, relative size, orientation and location of each pictograph in said message according to instructions from a user.

21. The mobile communication apparatus according to claim 14, wherein said message sending means is connected to communication means comprising an infrared data association (IrDA), a short range radio connection, a Bluetooth connection, a connection to a wireless local area network (WLAN), or a connection to a telecommunication network, or any combination thereof.

22. The mobile communication apparatus according to claim 14, wherein said message viewer is arranged to view said messages as they were composed in sense of relations, relative sizes, orientations and locations of pictographs comprised in said message.

23. The mobile communication apparatus according to claim 14, wherein said message viewer is arranged to change a three-dimensional viewpoint of said message according to instructions from a user.

24. The mobile communication apparatus according to claim 14, wherein said message receiving means is connected to communication means comprising an infrared data association (IrDA), a short range radio connection, a Bluetooth connection, a connection to a wireless local area network (WLAN), or a connection to a telecommunication network, or any combination thereof.
